(19) United States
(12) Patent Application Publication
(10) Pub. No.: US 2005/0247459 A1
(43) Pub. Date: Nov. 10, 2005

(54) Method for operating a disengagable screwdriver, and a disengagable screwdriver

(76) Inventors: Mike Voigt, Gaildorf (DE); Gerhard Sanwald, Fichtenberg (DE)

Correspondence Address: MICHAEL J. STRIKER, 103 EAST NECK ROAD, HUNTINGTON, NY, 11743, US

(21) Appl. No.: 11/119,612

(22) Filed: May 2, 2005

(30) Foreign Application Priority Data
May 4, 2004 (DE) 10 2004021930.3

(51) Int. Cl. B25D 1/00

(52) U.S. Cl. 173/1; 173/176

(57) ABSTRACT

The present invention is based on a method for operating a disengagable screwdriver (10) having a drive motor (12) and a shut-off device (20), with which a driving of a screw tool (16) is halted when a specified cutoff torque is reached.

It is proposed that the drive motor (12) is switched off before the specified cutoff torque is reached. A disengagable screwdriver (10) is also proposed.

### BACKGROUND OF THE INVENTION

The present invention is based on a method for operating a disengagable screwdriver, and a disengagable screwdriver.

The use of disengagable screwdrivers to screw parts to be joined has already been proposed, the disengagable screwdrivers screwing screws into the joining point and driving the screw only until a preset torque has been reached. When the torque is reached, a tool drive of the disengagable screwdriver is disengaged from drive power, e.g., by the triggering of a safety clutch and switching the drive motor off. To brake the drive train as quickly as possible when the cutoff torque is reached, the drive motor is typically short-circuited via its on/off switch.

### SUMMARY OF THE INVENTION

A method for operating a disengagable screwdriver is proposed, in the case of which its drive motor is switched off before a specified cutoff torque is reached. Current supply to the drive motor is interrupted even before the cutoff torque is reached. Advantageously, this makes it possible to brake the disengagable screwdriver in an economical and gentle manner when the cutoff torque is reached, since the drive motor has a slower speed when the cutoff torque is reached than it does in the typical braking procedure. The drive motor is preferably switched off when its remaining kinetic energy is sufficient to achieve the cutoff torque. In a favorable embodiment, all available kinetic energy from the drive motor, drive train, tool mount and tool is taken into account to achieve the cutoff torque when the drive motor is switched off.

Between an initial driving of the screw, i.e., when torque is increasing, and the point when the cutoff torque is reached, the angle of rotation during a “hard” screwing procedure is small, i.e., typically less than 50° and, e.g., 30°. As such, the drive motor need apply only a small amount of power. The drive motor has a high residual speed and/or kinetic energy that must be braked, whereby high short-circuit currents of, e.g., 50 to 80 A can occur in some cases. Due to the slower speed made possible by the method according to the present invention, markedly lower braking currents now occur when the drive motor is braked by short circuiting.

With a disengagable screwdriver powered by a rechargeable battery, the method according to the present invention therefore enables a longer life of the rechargeable battery since less energy is drawn from the rechargeable battery. The operator of the disengagable screwdriver experiences smaller reaction forces, thereby making operation of the disengagable screwdriver more comfortable. Stress on the drive motor is relieved due to a lesser braking current during short-circuiting and by a lesser final current when a screw is being tightened. Less stress is placed on mechanical components of a drive train of the disengagable screwdriver. Given the reduced braking current, less dissipated heat is produced, thereby reducing the thermal load on the drive and the entire disengagable screwdriver. Overall, the service life of the disengagable screwdriver is affected in an advantageous manner. The switching off according to the present invention is carried out preferably during a “hard” screwing procedure with angles of rotation of between 30° and 180°. With a “soft” screwing procedure, in the case of which the screw has a larger range of angular rotation, typically between the initial tightening of the screw and the point at which the cutoff torque is reached, e.g., 720°, the full power of the drive motor is required to achieve the cutoff torque. In a typical case of switching-off when the cutoff torque is reached, the drive motor has only a small amount of residual speed, which can be braked with a small amount of energy.

If the switching criterium for the remaining kinetic energy is selected as the point at which a specified value for the current rise over time of the drive motor is reached, then a simple measurement variable is available for switching off the drive motor. As an alternative, the point at which a specified value of a voltage drop over time is reached, e.g., a specified drop in voltage at the drive motor, can be selected as the switching criterium for the remaining kinetic energy.

If the current and/or current rise is used as the switching criterium, it is particularly advantageous to determine a current rise shortly before the cutoff torque is reached. This takes place preferably within a time interval of fewer than 100 ms before the cutoff torque is reached. It is favorable to determine an absolute value for the interrupt current based on a high current determined from the current rise plus a no-load current.

The screw tool is advantageously decoupled when the cutoff torque of the tool drive is reached. The actual switching-off and/or braking of the disengagable screwdriver can now take place at a markedly lower speed of a motor armature of the drive motor when the cutoff torque is reached and, as usual, by releasing a clutch, in particular a safety clutch.

Furthermore, a disengagable screwdriver is proposed, with which a means is provided to switch off a drive motor having kinetic energy before a cutoff torque is reached. The drive motor is preferably switched off when the remaining kinetic energy of the drive motor and/or the drive is sufficient to achieve the cutoff torque.

### BRIEF DESCRIPTION OF THE DRAWINGS

FIG. 1 shows a preferred disengagable screwdriver;

FIG. 2 shows a schematic of a current trace when a cutoff torque is reached, during a “hard” screwing procedure, with the switch-off procedure according to the present invention in comparison with a typical disengagable screwdriver; and

FIG. 3 shows a current-voltage trace of a typical disengagable screwdriver when a cutoff torque is reached, during a “soft” screwing procedure.

### DETAILED DESCRIPTION OF THE PREFERRED EMBODIMENTS

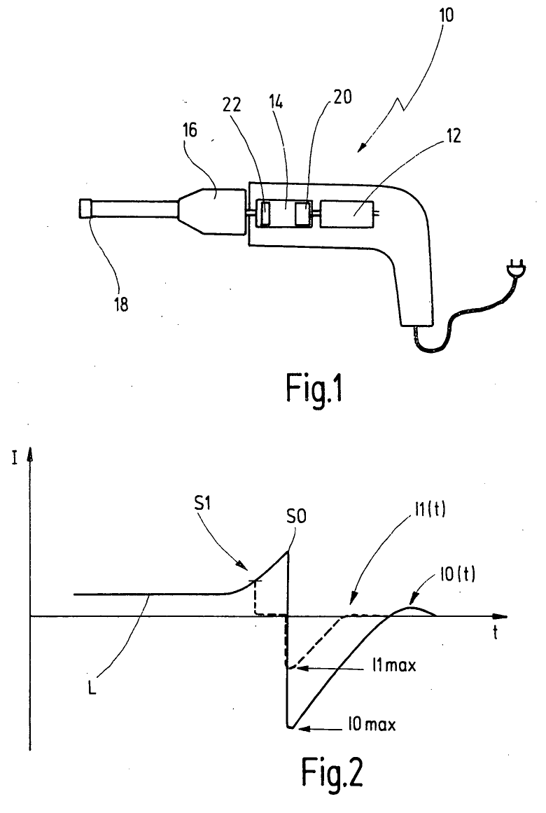

A preferred disengagable screwdriver 10 is shown in simplified form in FIG. 1. Disengagable screwdriver 10 includes a shutoff device 20, e.g., a safety clutch, to disengage a tool drive 14—that is driving a screw tool 18—when a cutoff torque is reached. Shutoff device 20 can be integrated in tool drive 14. Tool drive 14 includes, e.g., the coupling and gearset of disengagable screwdriver 10. A drive motor 12 drives, via a typical drive train—which includes the clutch and gearset and/or tool drive—a tool mount 16 and, therefore, screw tool 18. When the cutoff torque is reached, drive motor 12 is short-circuited, e.g., via its on/off switch (not shown), to brake the drive train as quickly as possible.

When drive motor 12 is energized, it converts the supplied electrical power into kinetic energy. A means 22 is provided to switch off drive motor 12 before the cutoff torque is reached, whereby its remaining kinetic energy is sufficient to achieve the cutoff torque. Drive motor 12 and/or its rotor is de-energized and its kinetic energy is utilized to perform the screwing procedure via the drive train (not shown) until the clutch (not shown) is triggered; the clutch is triggered when the cutoff torque is reached. Means 22 is preferably a computing means, in particular a microcontroller with appropriate programming designed for this purpose. According to the method, according to the present invention, for operating disengagable screwdriver 10, drive motor 12 is de-energized even before the cutoff torque is reached. The switching point is selected such that the remaining kinetic energy of the motor armature and/or motor rotor and drive train, in particular the gearset and clutch, and tool mount 16, are sufficient to achieve the cutoff torque. Disengagable screwdriver 10 can be powered by a rechargeable battery or mains power.

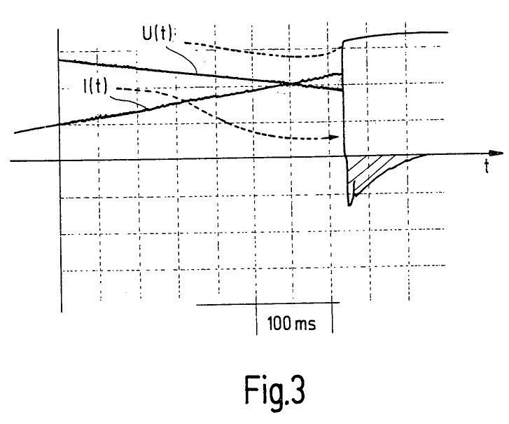

FIG. 2 shows a current trace I1(t) for a disengagable screwdriver 10 according to the present invention in comparison with a current trace I0(t) for a typical disengagable screwdriver during a “hard” screwing procedure. With a “hard” screwing procedure, e.g., when screwing in a threaded metal screw, a screw is driven at high speed and then tightened with a great deal of kinetic energy until the safety clutch is triggered at the cutoff torque and driving force is no longer applied to tool 18. A typical limit angle for a “hard” screwing procedure is, e.g., 30°. On the other hand, with a “soft” screwing procedure, as illustrated in FIG. 3 with reference to the typical current trace I(t) and voltage trace U(t), e.g., when screwing a screw into wood, the screwing procedure is carried out in a low gear with a continuously increasing load until the target torque is reached. A typical limit angle in this case is, e.g., 720° between the first driving motion of the screw until the cutoff torque is reached. The full power of the drive motor is required until the cutoff torque is reached. In the case of the typical switch-off, the drive motor has only a small amount of residual speed, which is now braked with a relatively low amount of energy.

The typical current trace I0(t) in FIG. 2 proceeds substantially constantly with a no-load current L until shortly before the target torque is reached. When the cutoff torque is reached, the current I0(t) increases rapidly within, e.g., typically fewer than 100 ms, and, when the cutoff torque is reached at point S0, it triggers the safety clutch, or tool 18 is disengaged from drive power in another suitable fashion, and a microswitch switches the current to drive motor 12 off and short circuits it to brake it. The current drops off quickly and reaches a negative minimum value I0max, and then climbs back up to zero. The area in the negative current region corresponds to the amount of braking energy to be applied. In contrast to current I0(t), the electrical voltage (not shown) exhibits a typical voltage drop to a minimum value during the current rise, and then increases back to its normal value.

With the method according to the present invention, in the case of a “hard” to “harder” screwing procedure with screwing angles between typically 30° to 180°, the attainment of a specified current rise over time by drive motor 12 is used as the switching criterium for the remaining kinetic energy, so that the current used to drive drive motor 12 is switched off at an earlier switching point S1, before the cutoff torque is reached. The information for the early switching-off is easily obtained from the slope of the current rise and/or the voltage drop during the screwing procedure. The absolute value for the interrupt current, which serves as the switching-off criterium, is determined from a high current determined from the current rise plus a no-load current. At this point in time, the screw is driven—by the kinetic energy of the armature of drive motor 12, which arises from resulting torque, which is equal to the product of a moment of inertia of the drive and an angular delay-until the cutoff torque is reached. The actual switching off and/or braking, which is carried out now at a markedly lower speed of the motor armature, however, then takes place again via disengagement of the clutch.

1. A method for operating a disengagable screwdriver (10) having a drive motor (12) and a shut-off device (20), with which a driving of a screw tool (16) is halted when a specified cutoff torque is reached,
wherein the drive motor (12) is switched off before the specified cutoff torque is reached.

2. The method as recited in claim 1,
wherein the drive motor (12) is switched off when its remaining kinetic energy is sufficient to achieve the cutoff torque.

3. The method as recited in claim 1,
wherein a specified value of a current rise over time by the drive motor (12) is used as the cutoff criterium for the remaining kinetic energy.

4. The method as recited in claim 1,
wherein a specified value of a voltage drop over time at the drive motor (12) is used as the cutoff criterium for the remaining kinetic energy.

5. The method as recited in claim 1,
wherein an absolute value for the interrupting current is determined based on a high current determined from the current rise plus a no-load current (L).

6. The method as recited in claim 1,
wherein the screw tool (18) is decoupled when a tool drive (14) reaches the cutoff torque.

7. The method as recited in claim 1,
wherein the drive motor (12) is short-circuited when the cutoff torque is reached.

8. A disengagable screwdriver with a drive motor (12) and a shutoff device (20) for halting a driving of a screw tool (18) when a specified cutoff torque is reached,
wherein means (22) are provided to shut off the drive motor (12) having kinetic energy before the cutoff torque is reached.

9. The disengagable screwdriver as recited in claim 8,
wherein the drive motor (12) is capable of being switched off when the remaining kinetic energy of the drive motor (12) is sufficient to achieve the cutoff torque.
